(19) United States
(12) Patent Application Publication
(10) Pub. No.: US 2020/0151554 A1
(43) Pub. Date: May 14, 2020

(54) MACHINE LEARNING BASED MODEL FOR SPECTRAL SCAN AND ANALYSIS

(71) Applicant: HEWLETT PACKARD ENTERPRISE DEVELOPMENT LP, Houston, TX (US)

(72) Inventors: Mohd Shahnawaz Siraj, San Jose, CA (US); Andre Beaudin, Montreal (CA); Qiang Zhou, Beijing (CN); Berend Dunsbergen, San Jose, CA (US)

(21) Appl. No.: 16/184,930

(22) Filed: Nov. 8, 2018

(51) Int. Cl. G06N 3/08

(52) U.S. Cl. CPC G06N 3/08

(57) ABSTRACT

Various aspects of the subject technology relate to methods, systems, and machine-readable media for classifying interfering devices. The method includes collecting data samples from a set of known interfering devices, the data samples having characteristics of the set of known interfering devices. The method also includes compiling known feature vectors corresponding to the characteristics of the set of known interfering devices. The method also includes executing the known feature vectors on machine learning algorithms to train the machine learning algorithms to classify the set of known interfering devices. The method also includes generating a machine learning model based on performances of the machine learning algorithms, the machine learning model including at least one of the machine learning algorithms. The method also includes executing future feature vectors corresponding to a set of future interfering devices on the machine learning model to classify the set of future interfering devices.

### BACKGROUND

A wireless local area network (WLAN) is a wireless computer network that links a plurality of devices using wireless communication to form a local area network (LAN) within a limited physical area such as a home or business. Devices connected by a WLAN share an unlicensed spectrum with other devices and networks. Oftentimes other commercial devices such as microwave ovens, cordless phones, video bridges, Bluetooth™, etc., also produce radio frequency (RF) signals in the same unlicensed spectrum on which the WLAN operates.

The RF signals emitted by unrelated devices may interfere with the operation of WLAN devices/networks. Detecting the presence of these interfering devices and classifying them is important to mitigate the impact such devices have on operation of the WLAN. Conventional approaches to detecting and classifying interfering devices is performed manually, which is time-consuming, inefficient, and error prone.

### BRIEF DESCRIPTION OF THE DRAWINGS

The following detailed description references the drawings, wherein:

FIG. 1 is a block diagram of an example networking environment having interfering devices;

FIG. 2 is a block diagram illustrating an example system architecture for data collection for building a machine learning model;

FIG. 3 is a block diagram illustrating an example system for developing a machine learning model for identifying interfering devices;

FIG. 4 is a block diagram illustrating an example system for identifying interfering devices with a machine learning model;

FIG. 5 is a block diagram illustrating an example system architecture for developing and implementing a machine learning model;

FIG. 6 illustrates an example flow diagram for classifying interfering devices; and

FIG. 7 is a block diagram illustrating an example computer system with which aspects of the subject technology may be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

WLAN devices share an unlicensed spectrum with other commercial devices, such as microwave ovens, cordless phones, video bridges, Bluetooth™ devices, etc., that also emit similar RF signals across the unlicensed spectrum. The RF signals emitted by these devices may interfere with the operation of WLAN devices/networks. Detecting the presence of, and classifying, these devices may assist in mitigating the impact thereof. Spectral scan and analysis may be used for detection and classification.

Conventional spectral scan and analysis approaches involve predefined static rules, which are developed by manually testing a spectral signature of an individual device and then searching for the same spectral signature amongst data collected from an area being observed, such as an area where a WLAN is operating. These static rules are tested and adjusted based on studying the signal patterns emitted from a few types and/or brands of devices. Thereafter, the signal patterns developed from the limited types and/or brands of devices observed are applied in an attempt to detect and classify any interfering devices present during scanning. However, every day numerous new devices are released into the consumer and business market, and devices in use deteriorate and change in operation. As a result, manual predefinition of static rules using test results from individual devices is open to erroneous rule entry and/or interpretation and presents scalability challenges. A system, apparatus, and/or method that utilizes machine learning algorithms to develop models for spectral scan and analysis represents an advancement in the art.

Disclosed is a machine learning model for classification of interfering devices that overcomes the deficiencies stated above. Sample data is collected and converted into fast Fourier transform (FFT) frames. Radio frequency (RF) characteristics of the FFT frames are represented in the form of feature vectors for training a set of machine learning algorithms, including, but not limited to, logistics regression (LR), artificial neural networks (ANN), and support vector machines (SVM). The machine learning algorithms are trained and optimized using the feature vectors as inputs, and the machine learning model is generated based on performance of each machine learning algorithm. The generated machine learning model may be implemented in an access point (AP) for automatic classification of interfering devices.

The disclosed methods, systems, and machine-readable media address a problem in traditional spectral scan techniques tied to computer technology, namely the technical problem of identifying multiple interfering devices in a scalable and efficient manner. The disclosed methods, systems, and machine-readable media solve this technical problem by providing a solution also rooted in computer technology, namely, by training and implementing a machine learning model for classifying interfering devices.

The disclosed subject technology further provides improvements to the functioning of the computer itself because it reduces costs, reduces errors, and increases efficiency. Specifically, machine learning algorithms automate and improve the process of classifier development for increased efficiency and accuracy in spectral classification. Additional improvements includes the ability to classify unknown devices based on a closest existing rule.

As used herein, “access point” (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

As used herein, “network device” generally includes a device that is adapted to transmit and/or receive signaling and to process information within such signaling such as a station (e.g., any data processing equipment such as a computer, cellular phone, personal digital assistant, tablet devices, etc.), an access point, data transfer devices (such as network switches, routers, controllers, etc.) or the like. For example, a “network device may refer to a network controller that comprises a hardware or a combination of hardware and software that enables connection between client devices and computer networks. In some implementations, a network device may refer to a server computing device (e.g., on-premise server, private, public, or hybrid cloud server) that comprises a hardware or a combination of hardware and software that can process and/or display network-related information. In some implementations, a network device may refer to an access point acting as a virtual master network controller among a cluster of access points.

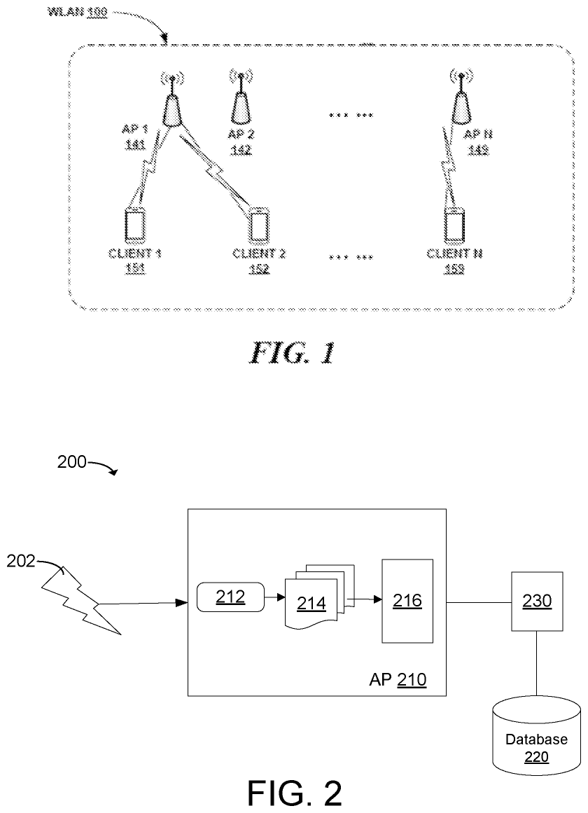

FIG. 1 is a block diagram of an example WLAN 100 (e.g., networking environment) for classifying interfering devices. WLAN 100 may include a plurality of network devices, including but not limited to access points AP 1 141, AP 2 142, . . . AP N 149, and a plurality of client devices, including but not limited to Client 1 151 Client 2 152, . . . , Client N 159. Each AP in WLAN 100 may provide wireless network access and services to one or more client devices. In the example WLAN 100, for illustration purposes only, assuming that Client 1 151 and Client 2 152 are both associated with AP 1 141; Client N 159 is associated with AP N 149; etc. In addition to client devices served by the APs (e.g., AP 1 141 to AP N 149) in WLAN 100, other devices may also transmit wireless signals at a particular frequency that overlaps with the frequency in at least one operating channel of an AP in the WLAN 100. In some examples, the AP may choose to operate on one of a plurality of supported wireless communication channels. In some examples, the frequency of interference signal may not overlap with the frequency of the current operating channel of the AP, it may nonetheless overlap with one of the plurality of supported wireless communication channels. The AP may detect such interference signals when it switches off its operating channel and perform a periodical spectral scan through a plurality of wireless communication channels supported by the AP.

A spectral report that contains data associated with the measurements recorded for the interference signal may be generated. Such data associated with the measurements may be processed using Fast Fourier Transform (FFT). FFT generally may refer to a mechanism that samples a signal over a period of time or space and divides it into a plurality of frequency components, which can also be referred to as FFT bins (e.g., FFT frames). These components or bins are single sinusoidal oscillations at distinct frequencies, each with their own amplitude and phase. This transformation over the time period measured may be graphed, and a FFT pattern associated with the interference device type may be identified. The FFT pattern may include a set of amplitudes and phases at each FFT bin. The APs (e.g., AP 1 141 to AP N 149) may use a plurality of classifiers of a machine learning model to classify the interference signal based on the FFT pattern. Although FFT samples are used for illustration here, data associated with the measurements may be processed by using any other suitable signal processing methods such as, for example, fractional Fourier transform (FRFT), linear canonical transform (LCT), Laplace transform (LT), etc.

When an AP performs spectrum monitoring, the AP may scan an assigned channel and collect FFT bins. The collected FFT bins may then be checked using classifiers to determine whether they may be classified as an interference because they match a known interference FFT pattern. The particular classifier used to classify the collected FFT bins may also provide information about the interference device type, vendor, etc. As will be described in more detail below, a machine learning based classifier model may be developed for improved accuracy and efficiency in classification of interfering devices.

The present disclosure contemplates systems and methods for using one or more machine learning techniques to classify interfering devices. In order to effectively leverage the disclosed machine learning technique(s), it is desirable during operation of the systems/methods for a relatively large amount of raw data/information to be collected from network hardware. The relatively large amount of raw data/information may then be subjected to a detailed analysis by software. Accordingly, flexibility and extendibility are increased for the systems/methods.

FIG. 2 is a block diagram illustrating an example system architecture 200 for data collection to build a machine learning model. The example architecture 200 may include an AP 210, a database 220, and a data collector 230. As described above in FIG. 1, the AP 210 may collect signals 202 (e.g., data samples) from interfering devices. For example, the signals 202 may be received by WLAN hardware 212 during a spectral scan and converted by the WLAN hardware 212 into FFT frames 214 (e.g., FFT bins). A WLAN driver 216 may then supply the FFT frames 214 to the data collector 230, where feature vectors (e.g., feature variables) are generated based on the FFT frames 214. For example, the feature vectors may be generated based on characteristics of the FFT frames 214, such as including, but not limited to, received signal strength indication (RSSI). The feature vectors are stored in the database 220. In an implementation, data from multiple APs may be stored in the database 220, for a larger collection of sample data.

According to an aspect, the FFT frames 214 may be collected and assembled together over a longer time period as an FFT array. For example, several consecutive FFT frames 214 may be assembled together for a better representation of frequency variation over time. Each bin value in the FFT array may be mapped as a feature vector.

According to aspects, the FFT frames 214 may be converted into several feature vectors based on various RF characteristics. A set of feature vectors may include, for example:

X1: RSSI values from each chain;

X2: center frequency;

X3: bin size;

X4: magnitude of FFT bins;

X5: bandwidth;

X6: number of strong in-band bins;

X7: magnitude of peak bin;

X8: in-band/out-band power ratio (dB step) for each FFT;

X9: average power in dB;

X10: total radio gain index at time of FFT (dB step);

X11: dB offset used to convert FFT log 2 bin magnitude to dBm;

X12: receiver chain index used (internal BB chain) for each FFT (e.g., for the internal radio baseband (BB) on which the FFT data is received);

X13: time offset of the FFT or spectral timestamp; and/or

X14: noise floor at the time of FFT collection.

It is understood that additional feature vectors may be generated based on additional RF characteristics of the FFT frames 214.

The feature vectors may be associated with one or more labels such as “Microwave”, “Cordless Phone”, “Video Bridge”, “Video Gaming System”, etc. For example, the FFT frames 214 may be collected from a known device, such as a microwave. A set of known feature vectors may be generated from the FFT frames 214 of the microwave. As a result, the set of known feature vectors may be mapped to (e.g., labelled as) the microwave. In an implementation, the known feature vectors may be indicative of a specific known device, which may be utilized for training a learning algorithm.

According to an aspect, training data and cross-validation data may be collected based on the FFT frames 214 and stored in the database 220. For example, the training data and the cross-validation data may include known feature vectors that are mapped to known devices. The known feature vectors may include a subset of all the feature vectors generated from all the FFT frames 214 collected. The training data may include a first subset of the known feature vectors, and the cross-validation data may include a second subset of the known feature vectors. As discussed below, the training data may be utilized to train a learning algorithm (e.g., machine learning algorithm), and the cross-validation data may be utilized to optimize the learning algorithm. In an implementation, test data may also be stored in the database 220 for testing of the learning algorithm. The test data may include a third subset of the known feature vectors. The first, second, and third subsets of the known feature vectors may be mutually exclusive.

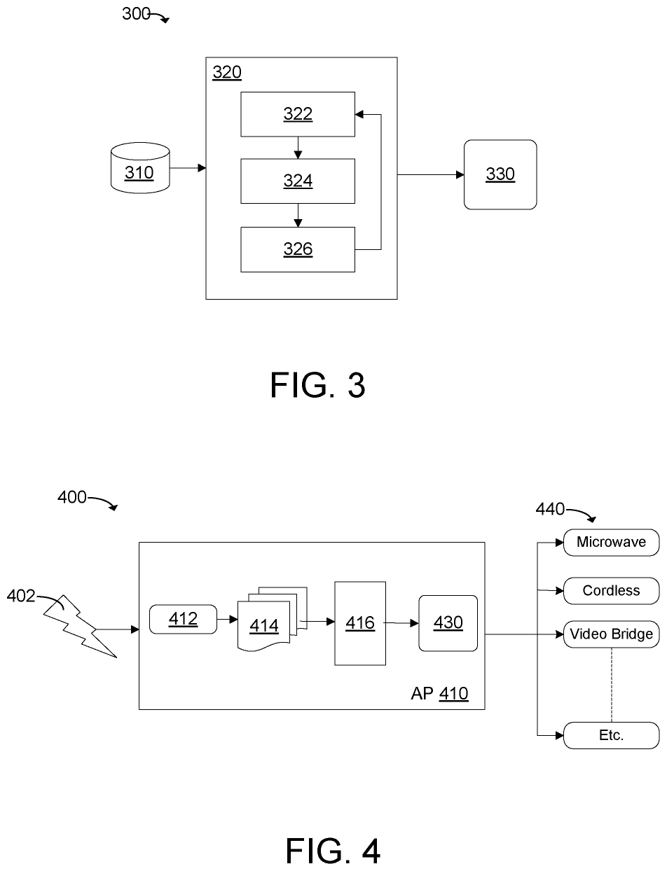

FIG. 3 is a block diagram illustrating an example system 300 for developing a machine learning model for identifying interfering devices. The system 300 utilizes stored training data and cross-validation data from a database 310 for training and optimizing a model generator 320 for generating a machine learning model 330. The database 310 may be generated similarly to the database 220 of FIG. 2.

The training data may include feature vectors and corresponding labelled devices for each feature vector for training the learning algorithms. For example, the feature vectors of the training data may be executed on the learning algorithms to train the learning algorithms to classify interfering devices. The learning algorithms may output weights for each of the feature vectors. For example, weights may be received for each of the feature vectors, which may be utilized for classifying interfering devices of the same type. In an implementation, a learning algorithm is trained to identify a microwave by executing feature vectors generated from detected microwave RF signals. The learning algorithm also receives a label corresponding to “Microwave” so that the learning algorithm knows the executed feature vectors are for a microwave. Weights are output for the executed feature vectors, which may be utilized for future classification of all microwave devices. This may be repeated for different types of devices (e.g., “Cordless Phone”, “Video Bridge”, “Video Gaming System”, etc.) for different learning algorithms (e.g., logistics regression, neural networks, support vector machines (SVM), etc.) until all of the learning algorithms are trained to identify all the devices.

According to an aspect of the present disclosure, the model generator 320 may receive known feature vectors from the database 310. For example, the known feature vectors may be selected from the training data. A selector 322 selects a learning algorithm to train, and executes the known feature vectors on the learning algorithm. Examples of learning algorithms may include, for example, logistics regression, neural networks, support vector machines (SVM), linear discriminant analysis, k-nearest neighbors algorithms, and/or other suitable supervised learning algorithms. The trained learning algorithm outputs weights of the known feature vectors for use in classification of future devices.

After training is finished, an optimizer 324 executes the cross-validation data on the trained learning algorithm to determine performance of the learning algorithm. For example, the cross-validation data may include only feature vectors from trained devices, such that the learning algorithm may utilize previously learned weights for outputting classifications of devices. Control parameters of the learning algorithm may be adjusted to improve the performance of the learning algorithm. Data assessor 326 may execute test data on the trained learning algorithm to determine accuracy of results. For example, the test data may include only feature vectors from trained devices and similar device types. The accuracy and/or other suitable measure of the learning algorithm is compared to that of other trained learning algorithms, and the learning algorithms having the best performance are included in the machine learning model 330. In an implementation, the model generator 320 may train, optimize, and test multiple learning algorithms simultaneously at the same time in parallel, or one at a time in series. One or more test data sets may also be used for developing control/baseline information for each of the learning algorithms under evaluation.

The machine learning model 330 may include at least one of the trained learning algorithms. The machine learning model 330 may also include a combination of many trained learning algorithms. For example, a situation may occur where one of the trained learning algorithms performs better at classifying interfering devices than all of the other trained learning algorithms. In that case, the best performing trained algorithm would be chosen as the machine learning model 330. There may also be a situation where different trained learning algorithms are better at classifying certain interfering devices than others. In this case, the machine learning model 330 may include a combination of all the learning algorithms that are best at classifying certain interfering devices. For example, if a first learning algorithm is best for classifying microwaves and a second learning algorithms is best for classifying cordless phones, then the first learning algorithm would be implemented for classifying microwaves and the second learning algorithm would be implemented for classifying cordless phones in the machine learning model 330. Because the machine learning model 330 is trained and optimized for a variety of learning algorithms, it will have optimized performance for automatic classification of a wide variety of interfering devices.

If a new type of device is released, FFT samples of the new device may be gathered and labelled and trained on the machine learning model 330 as discussed above. The algorithm would automatically learn the new device type and would be able to subsequently classify other similar devices. New rules regarding the new device may be pushed to the machine learning model 330 in the form of the algorithm parameter.

FIG. 4 is a block diagram illustrating an example system 400 for identifying interfering devices 440 with a machine learning model 430. For example, the machine learning model 430 may be generating similarly to the machine learning model 330 in FIG. 3. According to an aspect, the machine learning model 430 may be implemented in an AP 410. The machine learning model 430 may also be implemented in a cloud server with classification results being communicated to various APs.

According to an aspect of the present disclosure, raw data 402 may be detected by WLAN hardware 412 and converted to FFT frames 414. A WLAN driver 416 may then convert the FFT frames 414 into feature vectors for inputting into the machine learning model 430 for classification. The machine learning model 430 automatically classifies the interfering devices 440 based on the input feature vectors.

Because the machine learning model 430 is generated based on the optimized performances of multiple learning models, the resulting spectral classification is efficient and automatic. A user would not need to understand and analyze the RF characteristics of each device in order to configure or update the machine learning model 430. Classifiers may be designed quickly and with accurate spectral classification. This also results in reduced erroneous classification of unknown devices because the algorithm would match unknown devices to the closest matching rule. Additionally, the machine learning model 430 may be easily updated to detect new types of devices.

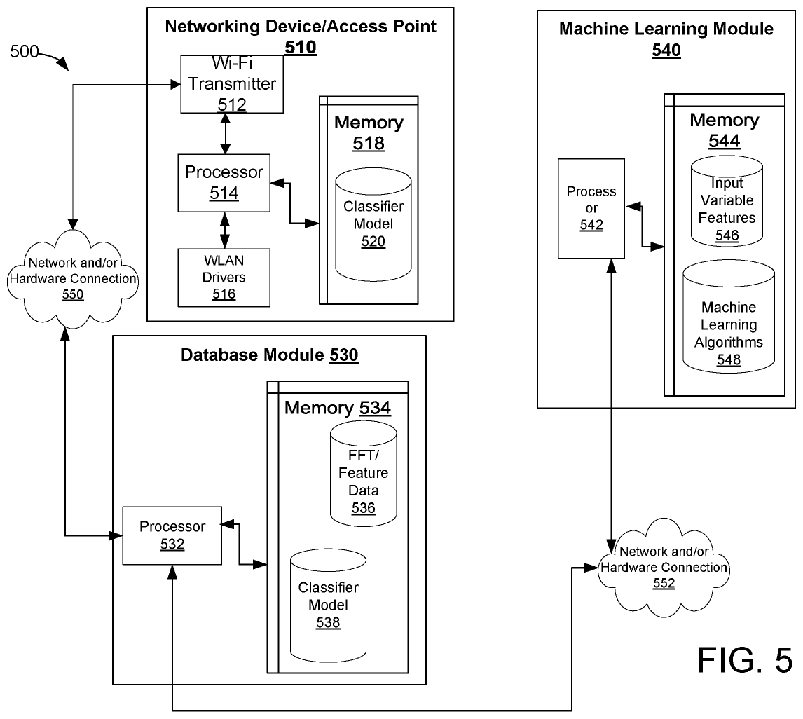

FIG. 5 is a block diagram illustrating an example system architecture 500 for developing and implementing a machine learning model, according to certain aspects of the disclosure. It is understood that the architecture 500 may include additional components that are not shown.

The architecture 500 may include an AP 510 coupled to a database module 530 through a network and/or hardware connection 550. The AP 510 may include a Wi-Fi transmitter 512, a processor 514, and WLAN drivers 516 coupled to each other. The processor 514 may also be coupled to memory 518, where a classifier model 520 is stored. The classifier model 520 may include the machine learning models 330 and 430 of FIGS. 3 and 4. For example, the AP 510 may include the APs described above in FIGS. 1, 2, and 4. The AP 510 may be configured to detect and store FFT frames as feature vectors, as described herein.

The database module 530 may include a processor 532 coupled to memory 534. The memory 534 may include FFT data 536 and a classifier model 538 (e.g., machine learning models 330 and 430 in FIGS. 3 and 4). The FFT data 536 may be received from the AP 510. According to an aspect, the database module 530 may include the databases 220 and 310 of FIGS. 2 and 3. The database module 530 may be coupled to a machine learning module 540 through a network and/or hardware connection 552.

The machine learning module 540 may include a processor 542 coupled to memory 544. The memory 544 includes input feature vectors 546 and machine learning algorithms 548. For example, the machine learning module 540 may train, optimize, and test the various machine learning algorithms 548 to generate the machine learning model 330 of FIG. 3. According to an aspect, the machine learning module 540 receives the input feature vectors 546 from the database module 530.

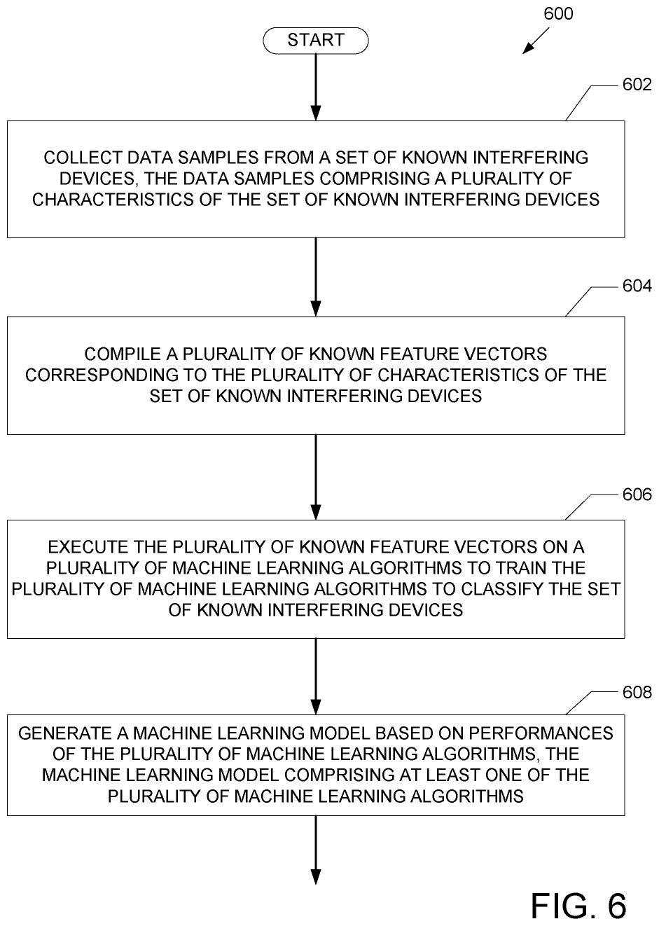

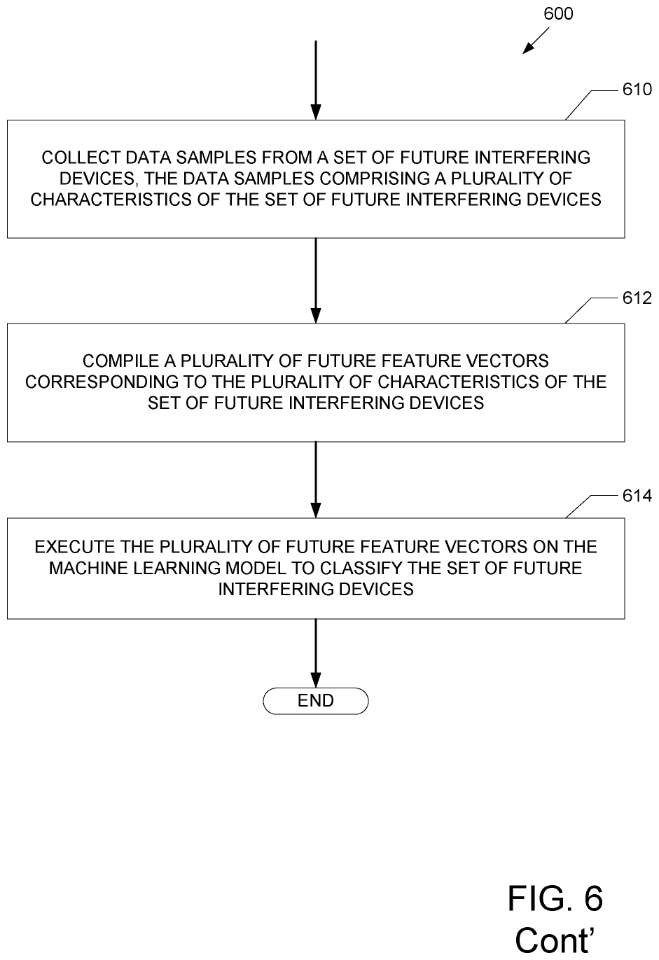

FIG. 6 illustrates an example flow diagram (e.g., process 600) for classifying interfering devices, according to certain aspects of the disclosure. For explanatory purposes, the example process 600 is described herein with reference to the systems and architectures of FIGS. 1-5. Further for explanatory purposes, the blocks of the example process 600 are described herein as occurring in serial, or linearly. However, multiple blocks of the example process 600 may occur in parallel. In addition, the blocks of the example process 600 need not be performed in the order shown and/or one or more of the blocks of the example process 600 need not be performed. For purposes of explanation of the subject technology, the process 600 will be discussed in reference to FIGS. 1-5.

At block 602, data samples are collected from a set of known interfering devices, the data samples including characteristics of the set of known interfering devices. At block 604, known feature vectors are compiled corresponding to the characteristics of the set of known interfering devices. At block 606, the known feature vectors are executed on machine learning algorithms to train the machine learning algorithms to classify the set of known interfering devices. At block 608, a machine learning model is generated based on performances of the machine learning algorithms, the machine learning model including at least one of the machine learning algorithms. At block 610, data samples are collected from a set of future interfering devices, the data samples including characteristics of the set of future interfering devices. At block 612, future feature vectors are compiled corresponding to the characteristics of the set of future interfering devices. At block 614, the future feature vectors are executed on the machine learning model to classify the set of future interfering devices.

According to an aspect, the process 600 further includes receiving from the machine learning algorithms weights for the known feature vectors. For example, weights may be received for each of the known feature vectors for classifying the known interfering devices.

According to an aspect, the process 600 further includes optimizing performance of each of the machine learning algorithms against cross-validation data, the cross-validation data including a subset of the known feature vectors. For example, the cross-validation data may include known feature vectors that were not utilized for training the machine learning algorithms.

According to an aspect, the process 600 further includes testing performance of each of the machine learning algorithms against test data, the test data including a set of unknown feature vectors. For example, the unknown feature vectors may be compiled from received RF signals from a set of unknown interfering devices. The unknown interfering devices may include devices that were not utilized for training, but may be of a same class as devices on which the machine learning algorithms were trained (e.g., a different microwave, a different cordless phone, etc.).

According to an aspect, the process 600 further includes mapping the known feature vectors to the set of known interfering devices. For example, the known feature vectors may be labelled according to their corresponding devices, such that the machine learning algorithm knows which device the known feature vectors are from, for training purposes.

According to an aspect, the process 600 further includes implementing the machine learning model in an access point (AP). For example, the machine learning model may be included in software of an AP. In implementations, the machine learning model may also be included on a cloud server for distribution to various APs. The various APs may also collectively upload collected RF signals to the machine learning model for continued training, optimization, and testing.

According to an aspect, the process 600 further includes receiving, from the machine learning model, classifications of future interfering devices. For example, the future interfering devices may include the known interfering devices and/or unknown interfering devices (e.g., devices of a similar type to what was utilized for training). The future interfering devices may also include new devices of a new class on which the machine learning model was not previously trained. In an implementation, the machine learning model may classify the new device to a closest existing classification, or may create (i.e., learn) a new class for classifying the new device.

According to an aspect, collecting the data samples includes detecting radio frequency (RF) signals emitted from wireless devices, sampling the RF signals over multiple time frames, generating fast Fourier transform (FFT) frames based on the RF signals, and converting the FFT frames into the known feature vectors. For example, received RF signals may be collected and compiled into feature vectors, as described above in FIGS. 1-2.

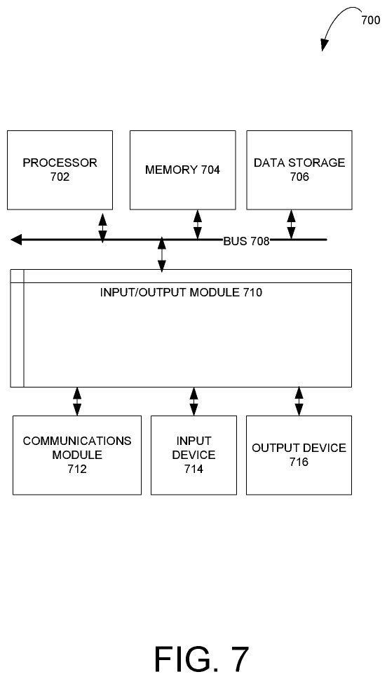

FIG. 7 is a block diagram illustrating an exemplary computer system 700 with which the systems and architectures FIGS. 1-5 may be implemented. In certain aspects, the computer system 700 may be implemented using hardware or a combination of software and hardware, either in a dedicated server, integrated into another entity, or distributed across multiple entities.

Computer system 700 includes a bus 708 or other communication mechanism for communicating information, and a processor 702 coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, for example, code that constitutes processor firmware, a protocol stack, a database management system, an operating system, or a combination of one or more of them stored in an included memory 704, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, i.e., one or more modules of computer program instructions encoded on a computer readable medium for execution by, or to control the operation of, the computer system 700, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multi-paradigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Exemplary input/output modules 710 include data ports such as USB ports. The input/output module 710 is configured to connect to a communications module 712. Exemplary communications modules 712 include networking interface cards, such as Ethernet cards and modems. In certain aspects, the input/output module 710 is configured to connect to a plurality of devices, such as an input device 714 and/or an output device 716. Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 716 include display devices such as a LCD (liquid crystal display) monitor, for displaying information to the user.

According to one aspect of the present disclosure, the WLAN 100, architecture 200, and system 300 can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in the main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include”, “have”, or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration”. Any embodiment described herein as “exemplary” is not necessarily to be construed as preferred or advantageous over other embodiments.

A reference to an element in the singular is not intended to mean “one and only one” unless specifically stated, but rather “one or more”. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A method, comprising:
collecting data samples from a set of known interfering devices, the data samples comprising a plurality of characteristics of the set of known interfering devices;
compiling a plurality of known feature vectors corresponding to the plurality of characteristics of the set of known interfering devices;
executing the plurality of known feature vectors on a plurality of machine learning algorithms to train the plurality of machine learning algorithms to classify the set of known interfering devices;
generating a machine learning model based on performances of the plurality of machine learning algorithms, the machine learning model comprising at least one of the plurality of machine learning algorithms;
collecting data samples from a set of future interfering devices, the data samples comprising a plurality of characteristics of the set of future interfering devices;
compiling a plurality of future feature vectors corresponding to the plurality of characteristics of the set of future interfering devices; and
executing the plurality of future feature vectors on the machine learning model to classify the set of future interfering devices.

2. The method of claim 1, further comprising:
receiving from the plurality of machine learning algorithms a plurality of weights for the plurality of known feature vectors.

3. The method of claim 1, further comprising:
optimizing performance of each of the plurality of machine learning algorithms against cross-validation data, the cross-validation data comprising a subset of the plurality of known feature vectors.

4. The method of claim 1, further comprising:
testing performance of each of the plurality of machine learning algorithms against test data, the test data comprising a set of unknown feature vectors.

5. The method of claim 1, further comprising:
mapping the plurality of known feature vectors to the set of known interfering devices.

6. The method of claim 1, further comprising:
implementing the machine learning model in an access point (AP).

7. The method of claim 1, further comprising:
receiving, from the machine learning model, classifications of future interfering devices.

8. The method of claim 1, wherein collecting the data samples comprises:
detecting a plurality of radio frequency (RF) signals emitted from a plurality of wireless devices;
sampling the plurality of RF signals over a plurality of time frames;
generating a plurality of fast Fourier transform (FFT) frames based on the plurality of RF signals; and
converting the plurality of FFT frames into the plurality of known feature vectors.

9. A system, comprising:
a memory; and
a processor executing instructions from the memory to:
collect data samples from a set of known interfering devices, the data samples comprising a plurality of characteristics of the set of known interfering devices;
compile a plurality of known feature vectors corresponding to the plurality of characteristics of the set of known interfering devices;
execute the plurality of known feature vectors on a plurality of machine learning algorithms to train the plurality of machine learning algorithms to classify the set of known interfering devices;
generate a machine learning model based on performances of the plurality of machine learning algorithms, the machine learning model comprising at least one of the plurality of machine learning algorithms;
collect data samples from a set of future interfering devices, the data samples comprising a plurality of characteristics of the set of future interfering devices;
compile a plurality of future feature vectors corresponding to the plurality of characteristics of the set of future interfering devices; and
execute the plurality of future feature vectors on the machine learning model to classify the set of future interfering devices.

10. The system of claim 9, wherein the processor further executes the instructions from the memory to:
receive from the plurality of machine learning algorithms a plurality of weights for the plurality of known feature vectors.

11. The system of claim 9, wherein the processor further executes the instructions from the memory to:
optimize performance of each of the plurality of machine learning algorithms against cross-validation data, the cross-validation data comprising a subset of the plurality of known feature vectors.

12. The system of claim 9, wherein the processor further executes the instructions from the memory to:
test performance of each of the plurality of machine learning algorithms against test data, the test data comprising a set of unknown feature vectors.

13. The system of claim 9, wherein the processor further executes the instructions from the memory to:
map the plurality of known feature vectors to the set of known interfering devices.

14. The system of claim 9, wherein the processor further executes the instructions from the memory to:
receive, from the machine learning model, classifications of future interfering devices.

15. The system of claim 9, wherein the processor further executes the instructions from the memory to:
detect a plurality of radio frequency (RF) signals emitted from a plurality of wireless devices;
sample the plurality of RF signals over a plurality of time frames;
generate a plurality of fast Fourier transform (FFT) frames based on the plurality of RF signals; and
convert the plurality of FFT frames into the plurality of known feature vectors.

16. A non-transitory machine-readable storage medium encoded with instructions executable by at least one hardware processor of a network device, the non-transitory machine-readable storage medium comprising instructions to:
collect data samples from a set of known interfering devices, the data samples comprising a plurality of characteristics of the set of known interfering devices;
compile a plurality of known feature vectors corresponding to the plurality of characteristics of the set of known interfering devices;
execute the plurality of known feature vectors on a plurality of machine learning algorithms to train the plurality of machine learning algorithms to classify the set of known interfering devices;
generate a machine learning model based on performances of the plurality of machine learning algorithms, the machine learning model comprising at least one of the plurality of machine learning algorithms;
collect data samples from a set of future interfering devices, the data samples comprising a plurality of characteristics of the set of future interfering devices;
compile a plurality of future feature vectors corresponding to the plurality of characteristics of the set of future interfering devices; and
execute the plurality of future feature vectors on the machine learning model to classify the set of future interfering devices.

17. The non-transitory machine-readable storage medium of claim 16, further comprising instructions to:
optimize performance of each of the plurality of machine learning algorithms against cross-validation data, the cross-validation data comprising a subset of the plurality of known feature vectors; and
test performance of each of the plurality of machine learning algorithms against test data, the test data comprising a set of unknown feature vectors.

18. The non-transitory machine-readable storage medium of claim 16, further comprising instructions to:
detect a plurality of radio frequency (RF) signals emitted from a plurality of wireless devices;
sample the plurality of RF signals over a plurality of time frames;
generate a plurality of fast Fourier transform (FFT) frames based on the plurality of RF signals; and
convert the plurality of FFT frames into the plurality of known feature vectors.

19. The non-transitory machine-readable storage medium of claim 16, further comprising instructions to:
receive from the plurality of machine learning algorithms a plurality of weights for the plurality of known feature vectors.

20. The non-transitory machine-readable storage medium of claim 16, further comprising instructions to:
receive, from the machine learning model, classifications of future interfering devices.
